(19) United States
(12) Patent Application Publication
(10) Pub. No.: US 2020/0236977 A1
(43) Pub. Date: Jul. 30, 2020

(54) STABILIZING AGENT FOR REDUCING THE LEACHING TOXICITY OF HEAVY METALS CONTAINED IN FOODS, FOODSTUFFS, CHINESE HERBS AND ENHANCING FOOD SAFETY AND ENVIRONMENTAL PROTECTION AND PREPARATION METHOD THEREOF

(71) Applicants: Jie LI, Shanghai (CN); Hangshin SHIH, New Milford, NJ (US)

(72) Inventors: Jie LI, Shanghai (CN); Hangshin SHIH, New Milford, NJ (US)

(73) Assignees: Terry Yu Tsai Shih, New Milford, NJ (US); Shani Shih, New Milford, NJ (US); Jennie Shih, New Milford, NJ (US)

(21) Appl. No.: 16/494,781

(22) PCT Filed: Mar. 17, 2017
(86) PCT No.: PCT/CN2017/077072

§ 371 Date: Sep. 17, 2019

(51) Int. Cl. A23L 5/20; A23L 29/00

(52) U.S. Cl. CPC A23L 5/276; A23V 2002/00; A23L 29/015

(57) ABSTRACT

The present invention relates to a stabilizing agent for reducing the leaching toxicity of heavy metals contained in foods, foodstuffs, Chinese herbs and enhancing food safety and environmental protection and its preparation method. The stabilizing agent is prepared by mixing the following raw materials: a phosphoric acid or phosphate, an acidity regulator and a chloride. The stabilizing agent of the present invention can be added directly to foods, foodstuffs, Chinese herbs during brewing, cooking or seasoning processes, that is, the stabilizing agent can reduce the leaching solubility of heavy metals contained in the foods, foodstuffs, Chinese herbs before entering the human mouth, stomach and intestines of human beings.

### BACKGROUND

### Technical Field

The present invention belongs to the technical field of food additives, particularly, it relates to a stabilizing agent for reducing the leaching toxicity of heavy metals contained in foods, foodstuffs, Chinese herbs and therefore enhancing both food safety and environmental protection and its preparation method.

### Description of Related Art

As far as human beings at the end of the food chain are considered, heavy metal contamination through the food chain is a global issue of great concern for human health. Once heavy metal enters the human body, it is not easy to excrete from body and would tend to accumulate in the brain, kidneys, or immune system. when such accumulation of heavy metal exceeds the body's physiological load, it can cause changes of physiological functions, resulting in acute and chronic diseases or generating long-term, adverse health effects, including gradual formation of cancerous tissues that cause cancer, seriously impacting body health, normal functions, and even loss of life. Such food safety hazards have seriously, harshly threatened public safety and social stability as well as the whole country's economy and well-being, situations are getting worrying.

However, at present, there is no generally suitable food grade product, nor a report disclosing a method or food grade product that would safely and cost-effectively reduce the leaching toxicity of heavy metals contained in foods, foodstuffs, that is, it is capable of converting dissolved, free heavy metals into a stable product that is poorly soluble and harmless, thus reducing its intake by organisms including crops, hence reducing its poison to organisms, preventing heavy metal from going back to the food chain and minimizing or avoiding its migration, spread and accumulation followed by amplification of poison or impacts. As a result, human being would not be the last stop of contamination of heavy metals in the food chain, instead, may be another start of amplification and spread due to accumulation followed by decomposition by gastric acid.

In China, soil has been currently polluted with heavy metals, resulting in crops and Chinese herbs contaminated with excessive heavy metals, and subsequently contamination in the food chain. The scandals of poisonous rice occurred frequently in several provinces of China has caused great concern of people in mainland China. As rice and rice-based products for example rice noodle are Chinese people's main foods, those rice noodle and rice cake made from “cadmium-containing rice” have been seriously impacted. A research report from Columbia University School of Public Health reveals that immigrants from the Chinese mainland have much higher blood levels of lead, cadmium, and mercury than other reference groups. When compared with local New Yorkers and New Yorkers of Asian heritage, their blood lead levels were 48.6% and 24.3% higher, their blood cadmium levels were 74% and 35.4% higher, while their blood mercury levels are 2.7 times and 1.8 times higher, respectively.

Since cadmium and lead can stay in the body for decades, this report suggested that the high blood levels of heavy metals cadmium and lead in Chinese immigrants were from China. The report concluded that this situation was mainly associated with their diets in China. In one aspect, the reason is Chinese people has a habit of taking the traditional Chinese medicine (Chinese herbs) that contains large amounts of heavy metals. Another more important reason is that the soil in China has been generally polluted by heavy metals, which subsequently contaminate the crops. But even taking a strong measure of remediation from now on, it would take up a thousand years to have contaminated soil remediated and restored once the soil is contaminated. However, the total amount of heavy metals in soil is not equal to the amount of heavy metals absorbed by crops and human body. Only those water-soluble, easily soluble (for example, decomposition in the acid) or in free form would be absorbed by organisms, such as crop roots. It would endanger drinking water source when these types of heavy metals are leached into the groundwater. There are always heavy metals in our living environment. There is still a small amount of heavy metals even in the soil that is not contaminated. Only those heavy metals with the bioavailable forms (i.e., biologically available to be absorbed), even particularly in high concentration due to special geological factors, would go through the food chain such as crops, Chinese herbs and generate poisons, affecting human health. From the viewpoint of the toxicology science, a heavy metal with low solubility is less toxic as it cannot easily be absorbed by the human body. The higher solubility of a poison in water, the greater its mobility and poisonous effect would be, and the greater its affinity, i.e., harmful impact, to the central nervous system. Poison with a low solubility in water is not easily absorbed into the blood. The mobility and solubility of a heavy metal are not only related to its total mass but also depend in a larger part on its existing form. Heavy metals in different forms have different mobility and solubility that subsequently cause different environmental impacts and human health effects. Generally speaking, reducing soluble, free heavy metals to the original mineral composition by “stabilization via chemically modifications” is a very simple and expeditious method for reducing the bioavailability and toxicity of the heavy metals, i.e. it can effectively reduce the absorption of heavy metals by crops, rice and improve the quality and production of agricultural products, and reducing the possibility of human intake of heavy metals or the material form of heavy metals that would be absorbed by human body.

Chinese invention patent CN102416396 B issued in 2014 discloses a heavy metal fixing agent for room temperature. The heavy metal fixing agent for room temperature includes based on the following percentage by weight: 30.0% to 40.0% of magnesium oxide, 55.0% to 65.0% of potassium dihydrogen phosphate, 3.5% to 5.0% of borax, 0.1% to 0.5% of iron oxide, 0.1% to 0.5% of silica dioxide. It also provides a method for fixing heavy metals in heavy metal contaminants. The fixing agent for room temperature according to this invention can realize utilization of the waste resource after curing the heavy metal waste at room temperature.

U.S. Pat. No. 5,202,033 (Chowdhury, et. al.) discloses a method for reducing heavy metals leaching by mixing phosphates including sodium phosphate (including sodium dihydrogen phosphate, disodium hydrogen phosphate, trisodium phosphate), and phosphoric acid and oxide of an alkaline earth metal such as calcium or magnesium with wastes.

U.S. Pat. No. 5,512,702 (Ryan, et. al.) shows an in-situ method for treating Pb contaminated soil using calcium phosphate compounds, in which calcium phosphate solid material is mixed with Pb contaminated soil. The calcium phosphate solid materials include naturally occurring apatite, synthetic hydroxyapatite, calcium hydrogen phosphate, or phosphate rock.

U.S. Pat. Nos. 7,736,291 and 7,530,939 of Forrester discloses a method wherein powdered calcium hydrogen phosphate dihydrate is used for effective stabilization and treatment of garbage incineration ash and incinerator bottom ash, which shows appreciable reduction of odor.

Another U.S. Pat. No. 5,797,992 (Huff) discloses a method for remediation of heavy metal contaminated environment, wherein calcium phosphate minerals such as naturally occurring apatite and synthetic hydroxyapatite are used to stabilize lead contaminated surface coatings and make it harmless. U.S. Pat. No. 6,001,185 (Huff) discloses another method utilizing calcium phosphate compounds to effectively treat heavy metal contaminated surface coatings, industrial by-products with heavy metal contamination, and industrial wastewater and stabilize heavy metals, including arsenic, lead, cadmium, chromium, nickel, and silver to be harmless to human and organisms. The calcium phosphate compound Huff used is at least one of naturally occurring apatite, synthetic hydroxyapatite, calcium hydrogen phosphate, or phosphate rock.

Although the prior art and technology under development has proved that phosphates have been successfully applied to the remediation of soil, garbage incinerator ash, bottom ash, heavy metal contaminated surface coating, heavy metal wastes, heavy metal contaminated industrial by-products and industrial wastewater, there is no domestic patented technology or a research achievement being able to provide a method or a food-grade product with reaction mechanisms and scientific substantiation that is capable of effectively reducing the leaching toxicity of soluble heavy metals contained in foods, foodstuffs, Chinese herbs during brewing, cooking, or seasoning processes or in the human stomach and intestines and converting them into a stable product that is harmless and chemically inactive, subsequently reducing its intake by human body or crops, and minimizing or preventing the heavy metals from going back to the food chain after they are excreted out of human body into environment, even there have been many popular detox or health foods in the market, including vitamin C, green algae, barley green powder, or dietary fiber foods such as cilantro, parsley, green beans, pumpkin, sweet potatoes, mushrooms, konjac, etc.

Chinese invention patent CN 101011432 B provides the application of extract of bracken flavonoids as a medicament for removing lead and relieving lead poisoning. By experiment, the use of 30-180 mg of extract of bracken flavonoids per kilogram of body weight per day can achieve substantial lead removal; while the use of 50-300 mg of extract of bracken flavonoids per kilogram of body weight per day would appreciably alleviate lead poisoning or treat lead poisoning. Chinese invention patent application CN 1506070 A discloses a stachyose-containing health care product for removing lead, with synergistic effect against lead toxicity and in reduction of lead absorption through a scientific ratio of calcium, zinc and iron. At the same time, stachyose supplement can not only adsorb heavy metal lead but also increases rapid proliferation of intestinal bacteria, bifidobacterium, that would appreciably shorten the bowel emptying time to promote lead excretion, providing effective prevention of and treatment to lead poisoning and poisonous damage. Chinese invention patent application (Application No. CN101933937 A) discloses the use of low molecular citrus pectin, a pectin extracted from citrus, in clinical practice of removing lead and heavy metals. It was confirmed through animal and clinical experiments that low molecular citrus pectin is different from the common chemical chelating agent, it can effective remove lead, mercury, and arsenic out of body without affecting key levels of other trace elements such as calcium, magnesium, zinc or minerals during removing poisonous substances. After taking 15 grams of citrus pectin daily, all subjects showed an appreciable reduction in mercury content, with average decrease of 72.17% in a range 38.13%-84.83%, without any side effects.

Chinese invention patent application (Application No. WO2013127146 A1) discloses a Lactobacillus plantarum that is capable of alleviating lead toxicity and its use. The Lactobacillus plantarum is Lactobacillus plantarum CCFM8661, which is resistant to acid, has a very good tolerance to lead ions in vitro and is able to withstand lead ion solution with a concentration of 150 mg/L lead with a very strong absorption to lead, can reduce lead content in mice blood, liver, kidney, stomach exposed to lead, substantially improving the antioxidant indicators of organisms of mice exposed to lead, relieving the pathology of mice exposed to lead.

Many other studies or articles have reported that many natural foods and antioxidants have a certain function of being resistant to lead and removal of lead as well as detoxification. Organic acids such as malic acid and citric acid are typical heavy metal chelating agents. The iodine and alginic acid contained in kelp can enhance lead excretion. The protein contained in milk can be combined with lead to form insoluble material; the calcium contained can prevent the absorption of lead. Polysaccharides and other macromolecules pectin, alginic acid and dietary fiber and other polysaccharide macromolecules all have the sugar chain riched in free —OH and —COOH groups that can be complexed with lead to form a gel difficult to be absorbed, effectively preventing lead from being absorbed in the gastrointestinal tract, hence promoting lead excretion. The sulfide contained in garlic and onions can dissolve the toxic effects of lead. Sea-buckthorn, roxburgh rose and kiwi fruit are rich in vitamin C that can prevent lead absorption, reducing lead toxicity. Vitamin B1, B2, B6, B12 and folic acid would be helpful in strengthening detoxification and promoting organ recovery. Lipoic acid, known as the “universal antioxidant”, also a heavy metal chelating agent, was early also used as an antidote for food poisoning or metal poisoning. Glutathione consisting of glutamic acid, cysteine and glycine, is an important antioxidant in the human body. The mercapto group of cysteine serves as its active group (abbreviated as G-SH), easily combining with toxins (such as free radicals, lead, mercury, arsenic and other heavy metals), and offering detoxification effect. Selenium has a function of detoxifying heavy metals, and is known as “natural antidote to heavy metals.” Selenium, a negative charge of non-metallic ions, can combine with positively charged heavy metal ions in organism to form a metal selenium protein complex compounds (ligand compounds), thus achieving detoxification and excretion. According to Reuters Health News New York News, the latest research results show that eating tofu would help reduce the concentrations of lead in human blood. Researchers have not yet known the mechanisms how tofu reduces the concentrations of lead in blood, but they suppose that calcium ions in soy products inhibit the absorption of lead and strengthen the protection from lead poisoning. Carrots containing large amounts of pectin that would bind to mercury are effective in removing mercury, thus reducing the concentration of mercury ions in the blood.

These natural foods and antioxidants, the patented bracken flavonoids extract, the patented stachyose-containing health care product and low molecular citrus pectin only show the function that they are capable of adsorbing, chelating or complexing free heavy metals, stimulate peristalsis, promoting excretion, and discharging heavy metals as fast as possible, but there is no scientific basis or reaction mechanism to prove that they are capable of substantially reducing leaching toxicity concentrations of those heavy metals hazardous to food safety, including lead, cadmium, arsenic, copper, mercury, and forming stable products of heavy metal that are harmless and chemically inactive. That is, after these heavy metals are discharged to the environment, they may be mostly reduced to harmfully soluble, free heavy metals, ultimately going back to food chain through migration, diffusion and conversion and eventually going back to the dining table. The metal complex is a complex ion or molecule formed by the combination of a metal ion (or atom) such as (Cu⁺², Zn⁺²) and a ligand with a covalent bond. Ligands are those containing molecules that provide lone pair electrons. N, O, S in organic molecules can provide lone pair electrons that interact with metal ions to form complexes. Chelate is a special complex, it refers to a complex with ring structure formed by coordination reaction among one or more groups and a metal ion. Chelates, also known as internal complexes, are generally more stable than complexes due to their cyclic structure. According to the practical experience in landfill using chelating agent and cement to solidify heavy metal contaminants, the chelating agent would be decomposed due to aging or reactions with foreign objects (such as acid rain) in the landfill environment with temperature, humidity and pH changing all the time. As a result, heavy metal cations would not be bonded any more but reduced to heavy metal atoms that will be leached back to the environment.

From a broad viewpoint, adsorbing, chelating, or complexing free heavy metals followed by discharging from human body is not a permanent solution, the heavy metals are only transferred and spread in the food chain cycle, as far as sustained economic development is concerned, the accumulation of heavy metal contamination in the ecosystem as well as enrichment and amplification of heavy metal pollution in the food chain will only become more and more serious, potentially threatening the sustainable development of agriculture, likely spreading through the food chain and harming more animals and people's lives and health, affecting quality of people's living environment and economy of community, government, and whole nation. Enrichment and spread of heavy metal contamination in the food chain is also food safety issues of global concern.

In addition, with the rapid development of Chinese economy, the level of urbanization and people's living standards continue to improve, daily amount of urban garbage is increasing. Among them, kitchen wastes that are easily degraded present 40-80% of the total amount of urban garbage. Kitchen wastes refer to food residues and food processing waste, mainly solid residues of kitchen waste.

Therefore, currently, it is urgently needed in China and those areas around the world where food chains are contaminated by heavy metals to innovate or develop a low-cost food-grade stabilization method or product that is applicable to domestic main foods, such as rice, as well as a variety of foods, foodstuffs, Chinese herbs via addition and stirring to effectively adsorb, chelate or complex heavy metals, such as lead, cadmium, arsenic, copper, mercury, contained in foods, foodstuffs, Chinese herbs during brewing, cooking, or seasoning processes, and reduce leaching toxicity of free heavy metals before foods, foodstuffs, Chinese herbs enter the human mouth, stomach, intestines, convert the heavy metals into stable products which are chemically inert, harmless, not absorbed by human body or organisms, and not easy to migrate, diffuse, or convert in the environment after they are excreted from the human body or when food residues or kitchen wastes are discarded randomly, piled up or landfill, therefore reducing the harm to the environment and reducing the possibilities of or preventing heavy metals from returning to food chains, so as to ensure maintenance of environmental quality, implementation of prevention and control of heavy metal pollutants, conservation of natural ecological safety.

### SUMMARY

The technical problem to be solved by the present invention is provide a stabilizing agent for reducing the leaching toxicity of heavy metals contained in foods, foodstuffs, Chinese herbs and therefore enhancing food safety and environmental protection and its preparation method, thereby preventing heavy metals from going back to the food chain and improving deficiencies of the prior art.

The stabilizing agent of the present invention reduces the leaching toxicity of heavy metals contained in foods, foodstuffs, Chinese herbs and therefore enhances food safety and environmental protection. Raw materials of the stabilizing agent are consisted of a phosphoric acid or phosphate, an acidity regulator and a chloride.

The phosphoric acid or phosphate is one or more selected from tricalcium phosphate, calcium dihydrogen phosphate, calcium hydrogen phosphate, sodium pyrophosphate, sodium hexametaphosphate, sodium trimetaphosphate, sodium tripolyphosphate, trisodium phosphate, tripotassium phosphate, sodium dihydrogen phosphate, potassium dihydrogen phosphate, disodium hydrogen phosphate, dipotassium hydrogen phosphate, disodium dihydrogen pyrophosphate, ammonium dihydrogen phosphate, diammonium hydrogen phosphate, tetrapotassium pyrophosphate, trisodium hydrogen phosphatepyrophosphate, potassium polymetaphosphate, calcium acid pyrophosphate, sodium aluminum acid phosphate among food additives approved by the National Food Safety Standard for Food Additive Use (GB2760) of China, magnesium hydrogen phosphate, calcium glycerophosphate hydrate, ferric pyrophosphate, casein phosphopeptide among food additives approved by the National Food Safety Standard for Food Additive Use (GB14880) of China, and phosphate-containing foods including bone meal, bone bouillon extract powder, fish meal. The phosphate includes non-soluble calcium phosphates. Preferred are calcium phosphates, including tricalcium phosphate, calcium dihydrogen phosphate, calcium hydrogen phosphate, since upon contacting the alkaline substance or environment, most of them would be rapidly converted to calcium hydroxyapatite, Ca₅(PO₄)₃(OH), i.e., mineral HydroxyApatite (referred to as HA), which is the source to start up reactions of substitution and precipitation with soluble, free heavy metal ions and form phosphate minerals and complex heavy metal minerals that are nontoxic, stable, very difficult to dissolve or break down even under extreme environment such as acid rain weather. In addition, calcium dihydrogen phosphate, calcium hydrogen phosphate can also be used as leavening agent, tricalcium phosphate, calcium hydrogen phosphate are nutrition enhancers that increase the calcium content of food.

The acidity regulator is phosphates among food additives approved by the National Food Safety Standard for Food Additive Use (GB2760) of China. The acidity regulator is one or more selected from tricalcium phosphate, calcium phosphate monobasic, sodium pyrophosphate, sodium trimetaphosphate, sodium tripolyphosphate, trisodium phosphate, tripotassium phosphate, sodium dihydrogen phosphate, potassium dihydrogen phosphate, disodium hydrogen phosphate, dipotassium hydrogen phosphate, disodium dihydrogen pyrophosphate, magnesium hydrogen phosphate, trimagnesium phosphate, calcium sulfate, calcium hydroxide, potassium hydroxide, magnesium oxide, lactic acid, calcium lactate, sodium lactate, sodium carbonate, potassium carbonate, potassium bicarbonate, sodium bicarbonate, sodium sesquicarbonate, sodium acetate, sodium citrate, sodium dihydrogen citrate, and potassium citrate. Preferred are potassium hydroxide, sodium carbonate, potassium carbonate, potassium bicarbonate, sodium bicarbonate, sodium sesquicarbonate, as they are quickly soluble in water and provide hydroxide (OH⁻) required for the synthesis of Hydroxyapatite. Less preferred are calcium hydroxide, sodium lactate, sodium tripolyphosphate, and a combination of sodium dihydrogen phosphate and disodium hydrogen phosphate, as calcium hydroxide can advantageously provide calcium required for rapid synthesis of Hydroxyapatite. Sodium tripolyphosphate solution, the combination of sodium dihydrogen phosphate and disodium hydrogen phosphate solution can provide a buffering capacity that would slow the change in pH and keep pH maintained at slightly alkaline, which would be favorable for reactions, reducing toxic, leaching concentrations of heavy metals and formation of harmless, stable complex phosphate mineral salts. Sodium lactate is not only used as an acidity regulator, but also has multifunction of being an antioxidant and a thickener, it would be of more helpful in expediting formation of the stable complex phosphate mineral salts.

The chloride is one or more selected from sodium chloride, potassium chloride, calcium chloride, magnesium chloride approved by the National Food Safety Standard for Food Additive Use (GB2760 and GB14880) of China Preferred is sodium chloride. Sodium chloride is a commonly used food preservative. It has osmosis function, can leach out heavy metals, particularly lead (Pb), and toxic chemicals contained in the foods, and enhance mobility of heavy metals, which subsequently increases the opportunity of being captured and adsorbed by dietary fiber as well as contacting and reacting with synthetic HydroxyApatite. Food grade chloride can also provide chloride complexing ions, which can substitute hydroxy in hydroxyapatite to obtain calcium chlorophosphate and accelerate precipitation of stable calcium chlorophosphate complex, which further reacts with dissolved, free heavy metals to form harmless, stabilized chloride complex minerals such as lead chlorophosphate mineral, cadmium chlorophosphate mineral (Pb₅(PO₄)₃(Cl), Cd₅(PO₄)₃(Cl)) and the like.

The raw materials of the stabilizing agent also include one or more selected from food or processed food containing dietary fiber, colloid, phlegm or riched in or being able to increase probiotic bacteria, food-grade iron compound, antioxidant, thickener, nutrition enhancer and preservative.

Food containing the dietary fiber, colloid, phlegm or riched in or being able to increase probiotic bacteria is one or more selected from fruits and vegetables, cereal grains, legumes as well as bacteria and algae foods such as blue-green algae, edible fungus/mushrooms including yeast, black fungus, Ganoderma lucidum, mushrooms, agaricus campestris, poria and the like, algae including brown algae, red algae, green algae and diatoms, figs, pumpkin, papaya, sweet potato, sweet potato leaves, bitter gourd, bamboo shoots, winter bamboo shoots, asparagus, carrots, white radish, onions, lotus seeds, lotus root, spinach, celery, coriander, ceylon spinach, broccoli, cauliflower, cabbage, bean sprouts, Gynura bicolor DC, Chinese leeks, eggplant, avocado, lemon, hawthorn, pueraria lobata root, common yam rhizome, perilla, nuts, ginger, garlic, chili, pepper, zanthoxylum, green pepper, purple sweet potato, potato, taro, fenugreek, natto, black-eyed beans, butter (lima) beans, soybeans, red beans, mung beans, black beans, green soya bean, rice including white rice, brown rice and embryo rice, etc., flaxseed, corn, millet, oats, barley, okra, sesame seeds, burdock, yellow soy milk, black soy milk, lentils, grapes, grapefruit, guava, dates, jujube, plum, etc.; foodstuffs containing dietary fiber, colloid, phlegm, or riched in or being able to increase probiotic bacteria is a processed food made from plants, vegetables, fruits, cereals, grains, beans, algae foods, or milk as raw material, health foods, sauces or thickeners, such as tea polyphenols, metallothionein, chicken powder, barley green powder, ginseng powder, yeast powder, yogurt, miso, pickled vegetables, fermented soya beans, blue-green algae products such as hair-like seaweed, spirulina, green algae products such as enteromorpha, ulva lactuca, brown algae products such as kelp, sodium alginate, red algae products such aslaver, furcelleran products such as carrageenan gum, agar etc., prebiotic food products such as stachyose, inulin, soluble soybean polysaccharide, polydextrose, resistant dextrin, flax seed powder, taro paste, wheat germ powder, poria cocos powder, pueraria lobata root powder, mung bean flour, red bean powder, black soybean powder, bean sprouts powder, almond powder, walnut powder, kelp powder, spices powder, lilac powder, licorice powder, curry powder, turmeric powder, cumin powder, fennel powder, chili powder, pepper powder, spiced salt, shichimi (seven spice powder), fenugreek powder, pumpkin powder, papaya powder, coconut powder, bitter gourd powder, pollen, carrot powder, chickpea flour, black fungus powder, mushroom powder, agaricus campestris powder, pea flour, green soybean powder, peanut flour, multiple grains (cereals) powder, cocoa powder, spinach powder, coriander powder, Chinese yam powder, perilla powder, hawthorn powder, plum powder, lemon powder, yam powder, mountain morning glory root powder, purple sweet potato flour, food starch including potato flour, tapioca flour, potato starch and lotus root flour, lily flour, potato flour, konjac flour, apple powder, grape powder, jujube powder, sour jujube powder, ginger powder, garlic powder, milk powder, soybean milk powder, barley flour, sesame flour, rice noodles, rice, noodles, flour, fruit juices such as papaya juice, sugarcane juice, grape juice, pineapple juice, lemon juice, orange juice, grapefruit juice, prune juice, mango juice, tomato juice, cranberry juice, pudding, honey, syrup, cereal, rice sauce, noodles sauce, sweet sauce, barbecue sauce, hoisin sauce, jelly, jam, cranberry sauce, fried bean sauce, tomato sauce, sesame sauce, peanut butter, chili sauce, mustard sauce, guacamole, salad dressing, barbeque sauce, stats sauce, teriyaki sauce, soy sauce, pectin, guar gum, fenugreek gum, locust bean gum and the like.

The food or processed foodstuff containing dietary fiber, colloid, phlegm, or riched in or being able to increase probiotic bacteria is preferably one or more selected from those with a pH range of 6.0 or higher (to avoid excessive consumption of free hydroxyl radicals and favor synthesis of HA from phosphates), including sodium alginate, inulin, alkalized cocoa powder, lotus root starch, mushroom powder, bitter gourd powder, kelp powder, curry powder, chili powder, black fungus powder, coriander powder, coconut flour, red bean flour, black bean flour, barley flour, wheat germ meal, yam powder, walnut powder, tapioca flour, purple sweet potato flour, konjac powder, and the like.

The food-grade iron compound is one or more selected from iron oxide black, iron oxide red among food additives approved by the National Food Safety Standard for Food Additive Use (GB2760) of China and nutrition enhancer iron compound approved by the National Food Safety Standard for Food Additive Use (GB14880) of China, including ferrous sulfate, ferrous gluconate, ferric ammonium citrate, ferrous fumarate, ferric citrate, ferrous citrate, ferrous lactate, chlorohemin, ferric pyrophosphate, iron porphyrin, ferrous glycinate, reduced iron, ferric sodium EDTA, carbonyl iron powder, ferrous carbonate, ferrous fumarate, ferrous succinate, heme iron, electrolytic iron and the like. Preferred is ferrous sulfate, which is easily soluble in water and can provide iron complex ions and sulfate ions that would accelerate formation of stable, complex lead iron phosphate mineral (Corkite), which has the lowest solubility of all currently known complex lead phosphate minerals.

The antioxidant is one or more selected from vitamin E, disodium EDTA, calcium disodium EDTA, sulfur dioxide, potassium metabisulfite, sodium metabisulfite, sodium sulfite, sodium hydrogen sulfite, sodium hydrosulfite, ascorbic acid (vitamin C), D-erythorbic acid and its sodium salt, sodium ascorbate, calcium ascorbate, ascorbyl palmitate, phospholipids, propyl gallate, antioxidant of glycyrrhiza, phytic acid, sodium phytate, bamboo leaf antioxidants, rosemary extract, tea polyphenols, tea polyphenols palmitate, and lipoic acid, L-methionine, glutathione, cysteine, taurine, and the like among food additives approved by the National Food Safety Standard for Food Additive Use (GB2760) of China.

The thickener is one or more selected from propylene glycol, tara gum, starch acetate, sodium carboxymethyl starch, acid-treated starch, sodium starch phosphate, aluminum starch octenyl succinate, oxidized starch, oxidized hydroxypropyl starch, β-cyclodextrin, gum arabic, guar gum, carrageenan, Cassia tora, gelatin, curdlan, pectin, locust bean gum, funoran, ablmoschus manihot gums, xanthan gum, Sa-son seed gum, sesbania gum, linseed gum, gleditsia sinensis lam gum, gellan gum, agar, propylene glycol alginate, chitin, chitosan, alginic acid, sodium alginate, potassium alginate, maltitol, lactitol, sorbitol, pullulan, soluble soybean polysaccharide, tamarind polysaccharide gum, carboxymethyl cellulose, propyl methyl cellulose, carboxymethyl cellulose sodium, polyglyceryl fatty acid ester, distarch phosphate, phosphated distarch phosphate, acetylated distarch phosphate, acetylated distarch adipate and the like among food additives approved by the National Food Safety Standard for Food Additive Use (GB2760) of China.

The nutrition enhancer is one or more selected from nutrition enhancers including calcium carbonate, calcium gluconate, calcium citrate, calcium lactate, calcium L-lactate, calcium hydrogen phosphate, calcium L-Threonate, calcium glycinate, calcium aspartate, citric acid, calcium malate, calcium acetate, calcium chloride, tricalcium phosphate (calcium phosphate), vitamin E, calcium succinate, calcium glycerophosphate, calcium oxide, calcium sulfate, bone meal (ultra-fine fresh bone meal), sodium selenite, sodium selenate, selenium protein, selenium-rich edible fungus powder, L-selenium-methylselenocysteine, selenium carrageenan, selenium yeast, casein phosphopeptide, casein calcium peptides, taurine, L-methionine, L-lysine, L-carnitine, vitamin B1, B2, B6, B12, folic acid, and the like, approved by the National Food Safety Standard for Food Additive Use (GB14880) of China. Preferred are calcium hydrogen phosphate, tricalcium phosphate (calcium phosphate), and calcium carbonate. Calcium hydrogen phosphate and tricalcium phosphate (calcium phosphate) can provide a source for the formation of calcium hydroxyapatite. Calcium carbonate is able to provide calcium that is needed and favorable for the rapid synthesis of calcium hydroxyapatite, particularly when applying to foods and foodstuffs that do not contain high content of calcium. In addition, due to its small molecule, calcium carbonate is more easily absorbed by human skeleton clinically than other calcium supplements.

The preservative is one or more selected from potassium cinnamate, cinnamaldehyde, ε-polylysine hydrochloride, ε-polylysine, nisin, sodium diacetate, sorbic acid and its potassium salt and the like. Preferred are ε-polylysine hydrochloride, ε-polylysine, and potassium cinnamate.

The use of appropriate preservatives also helps to enhance food safety. The US Food and Drug Administration (FDA) classified food safety issues into the following six categories in sequence based on the degree of harm: pathogens and pathogenic microbes, nutritional hazards, environmental pollutants, natural toxins, pesticides residues and food additives. Among them, “pathogens and pathogenic microbes” is ranked the first major issue with most serious harm as the microbes in nature is omnipresent, which is also why microbial food safety problems are more serious.

ε-polylysine hydrochloride or ε-polylysine is applicable in a wide range of pH (at pH 2 to 9), and does not decompose at temperature of up to 120° C. for 20 mins or longer due to an excellent thermal stability, being capable of inhibiting heat-resistant bacteria. Therefore, food with addition of ε-polylysine hydrochloride or ε-polylysine can be heated. ε-polylysine hydrochloride or ε-polylysine can not only inhibit fungi and gram-positive bacteria, but also has a strong inhibitory effect against bacteria causing food poisoning and septic such as Enterobacter aerogenes, Pseudomonas putida, Pseudomonas aeruginosa, proteus vulgaris, Escherichia coli, jejunum campylobacter, Salmonella typhimurium of gram-negative bacteria family. ε-polylysine hydrochloride, ε-polylysine not only inhibit the Gram-negative E. coli, Salmonella bacteriostasis that other natural preservatives (such as Nisin) are not easy to inhibit, but also has an inhibitory effect against growth of some viruses including lactobacillus bulgaricus, Streptococcus thermophilus, and yeast. ε-polylysine hydrochloride, ε-polylysine are homologues of L-lysine, which would be decomposed in the human body to Lysine and can be completely digested and absorbed by human body. Lysine is one of the eight essential amino acids that can promote human development, enhance immune function, and increase the active acid that would improve the function of central nervous system. Therefore, ε-polylysine hydrochloride and ε-polylysine are nutrient-type antibacterial agents, and their safety with an acute oral toxicity of LD50 of 5 g/kg is higher than other chemical preservatives. Due to the low content of L-lysine in cereals, and it is so easy to be destroyed as to lose during production processes, it is called the first restricted amino acid, which is also enhanced amino acid allowed by all countries in the world as food additives. Potassium cinnamate and sorbic acid are recommended by International Food and Agriculture Organization and WHO as efficient and safe preservatives, with a strict requirement of dosage for sodium sorbate and a proposal of gradual cancellation, but without any restrictions on the dosage and daily intake of potassium cinnamate as it is non-toxic. China also has strict rules on the dosage of benzoic acid, sorbic acid but no requirement on potassium cinnamate contained in the dairy products.

The heavy metal is one or more selected from soluble ions of lead, cadmium, copper, arsenic, mercury, and the like.

The basic components and their mass percentage ranges in the product of the present invention are as follows:

| | |
|---|---|
| Phosphate | 0.5-90%; |
| Acidity regulator | 0.5-65%; |
| Food-grade chloride | 0.5-40%; |
| Food or processed foodstuff containing dietary | 0-98%; |
| fiber, colloid, phlegm or riched in or being | |
| able to increase probiotic bacteria | |
| Food grade iron compound | 0-5%; |
| Antioxidant | 0-5%; |
| Thickener | 0-5%; |
| Nutrition enhancer | 0-5%; |
| Preservative | 0-2%. |

The raw materials mentioned above are stirred and mixed evenly in a certain proportion at normal temperature and pressure.

There are a lot of choices for the composition of the raw materials and their mass percentage of the present invention, which can vary in a great range, depending on many factors:

The use and its typical usage amount of processed foodstuff containing dietary fiber, colloid, phlegm or riched in or being able to increase probiotic bacteria used in the product of the present invention, for example, if mushroom powder is selected as seasoning for noodle products, such as regular instant noodle seasoning (only a small amount added in each soup bowl, for example, 1 g) in the product of the present invention, the basic components and their mass percentage range can be:

| | |
|---|---|
| Mushroom powder | 40-70%; |
| Phosphate | 5-50%; |
| Acidity regulator | 5-20%; |
| Food-grade chloride (NaCl) | 0.5-20%. |

The raw materials mentioned above are stirred and mixed evenly in a certain proportion at normal temperature and pressure.

If pumpkin powder is selected to make pumpkin powder solid drink (10 g pumpkin powder directly dissolved in 250 ml hot water to brew) as a dietary fiber supplement in the product of the present invention, the basic components and their mass percentage range can be:

| | |
|---|---|
| Pumpkin powder | 75-98%; |
| Phosphate | 0.5-20%; |
| Acidity regulator | 0.5-10%; |
| Food-grade chloride (NaCl) | 0.5 to 5%; |

The raw materials mentioned above are stirred and mixed evening in a certain proportion at normal temperature and pressure.

If the product of the present invention is applied to a vegetable riched in fiber itself, to make pickles as ingredients, if the amount of added ingredients does not exceed 10%, according to the general content of salt in pickles is 2% to 4%, the basic components and their mass percentage range can be:

| | |
|---|---|
| Phosphate | 0.5-60%; |
| Acidity regulator | 0.5-10%; |
| Food-grade chloride (NaCl) | 20-40%. |

The species and the degree of contamination of heavy metals (leaching toxic concentrations of various heavy metals) contained in the foods, foodstuffs, Chinese herbs that the product of the present invention is added to during soaking, brewing, cooking, or seasoning, for example, cadmium, copper contaminated oysters, arsenic contaminated rice, or Chinese medicine Babao powder with excess of mercury, lead, the more species of heavy metals, or the higher leaching toxic concentrations of heavy metals, the more amounts of phosphate and/or chloride would be needed; the more sever lead (Pb) contaminated food is, the more amount of food-grade iron compound may be needed.

The composition of the foods, foodstuffs itself that the product of the present invention is added to during soaking, brewing, cooking, or seasoning, for example, whether containing enough calcium, NaCl or chloride, iron ions, sulfate ions, and dietary fiber, colloid, phlegm or riched in or being able to increase probiotic bacteria substances or not; for example, contaminated rice and rice products containing trace amounts of calcium, dietary fiber would need relatively large amounts of calcium phosphate and food containing dietary fiber, colloid, phlegm, thickener.

The softness of foods, foodstuffs that the product of the present invention is added to during soaking, brewing, cooking, or seasoning, for hard, fried foods and dried fruits, a large amount of raw materials or ingredients such as calcium phosphates with functions of bulking or leavening can be used.

The pH of foods, foodstuffs that the product of the present invention is added to during soaking, brewing, cooking, or seasoning, the lower the pH value, the more amount of alkaline acidity regulator is needed.

The added amount of the product of the present invention depends on the amount of foods, foodstuffs, Chinese herbs, the species of heavy metals contained and the leaching toxic concentrations of heavy metals.

The reaction mechanisms that the product of the present invention reduces the leaching toxicity of heavy metals contained in the foods, foodstuffs, Chinese herbs during brewing, cooking, or seasoning and renders the heavy metals stable and harmless is as follows:

The main key reaction mechanism is: a series of Gibbs free energy effects generate spontaneous reactions of substitution and precipitation. Since packaging a mixture with bag or can after uniformly stirring and mixing raw materials followed by sterilization, phosphoric acid or part of phosphates, alkaline acid regulator and chloride start to react to convert to calcium hydroxyapatite, calcium chlorophosphate (chlorapatite) due to the significant differences in solubility, Gibbs free energy. In the water added for soaking, brewing, cooking, or seasoning, the unreacted phosphates would rapidly react with hydroxide ion, calcium ion, chloride ion to synthesize calcium hydroxyapatite, calcium chlorophosphate. Further, due to the significant differences in solubility, Gibbs free energy between calcium hydroxyapatite, calcium chlorophosphate and complex heavy metal chloroapatite or complex heavy metal Hydroxyapatite, calcium hydroxyapatite and calcium chlorophosphate would proceed reactions of substitution and precipitation with free heavy metals contained in foods, foodstuffs, Chinese herbs and form indecomposable, chemically inert, stable, nontoxic complex heavy metal minerals, such as pyromorphite Pb₅(PO₄)₃(Cl), Hydroxypyromorphite Pb₅(PO₄)₃(OH), Corkite PbFe₃(PO₄)(OH)₆SO₄, Cadmium Hydroxyapatite Cd₅(PO₄)₃(OH), Cadmium Chloroapatite Cd₅(PO₄)₃(Cl), Copper Hydroxyapatite Cu₅(PO₄)₃(OH), Copper Chloroapatite Cu₅(PO₄)₃(Cl), Johnbaumite Ca₅(AsO₄)₃(OH), Turneaureite Ca₅(AsO₄)₃(Cl), and Mercury (II) Phosphate Hg₃(PO₄)₂, etc. Secondly, via dietary fiber, colloid, phlegm or probiotic substance and/or iron compounds, thickeners, antioxidants, nutritional enhancers to adsorb, chelate or complex and fix free heavy metals, combined with actions of winding, knotting, to cause a “thermodynamic” balance effect and accelerate the Gibbs effect to proceed reactions of heavy metal substitution and precipitation.

Acidity regulator preferably used in the product of the present invention is sodium carbonate, potassium carbonate, potassium bicarbonate, sodium bicarbonate, sodium sesquicarbonate dihydrate and potassium hydroxide, which is water-soluble and provides hydroxide ions required for phosphates to rapidly synthesize HA.

From the viewpoint of chemical reaction thermodynamics, the chemical reaction would move in the direction of lower Gibbs free energy (enthalpy) (ΔG<0) at a certain temperature and pressure conditions. And the greater the negative value ΔG is, the greater the thermodynamic driving force for the reaction. Calcium phosphates such as Ca₃(PO₄)₂ is less stable than Hydroxyapatite Ca₅(PO₄)₃(OH), that is, the Gibbs free energy of Hydroxyapatite Ca₅(PO₄)₃(OH) is lower than that of Calcium phosphate Ca₃(PO₄)₂ due to the solubility(Ksp) of Ca₃(PO₄)₂ at 25° C. is 2.07χ10⁻³³, while the solubility(Ksp) of Ca₅(PO₄)₃(OH) at 25° C. is 6.8×10⁻³⁷ or ˜1×10⁻³⁶(refer to Lide DR Handbook of Chemistry and Physics.82nd edition. Boca Raton: CRC Press, 2001). Further, Hydroxyapatite Ca₅(PO₄)₃(OH) is less stable than calcium chlorophosphate Ca₅(PO₄)₃(Cl), that is, the Gibbs free energy of calcium chlorophosphate Ca₅(PO₄)₃(Cl) is lower than that of Hydroxyapatite Ca₅(PO₄)₃(OH) due to the solubility(Ksp) of Ca₅(PO₄)₃(Cl) at 25° C. is 10^{-46.89}(refer to B. S. Crannell et al./Waste Management 20 (2000)). Therefore, if there are hydroxide and chloride ions provided by sodium chloride (NaCl) or chloride, the following spontaneous reactions of sodium phosphate and calcium phosphate due to Gibbs effect would take place.

Sodium phosphate+calcium carbonate+OH⁻(aq)→Ca₅(PO₄)₃(OH)(s),Hydroxyapatite

Calcium phosphate+OH⁻(aq)→Ca₅(PO₄)₃(OH)(s),Hydroxyapatite

Hydroxyapatite Ca₅(PO₄)₃(OH)(s)+sodium chloride(NaCl) or chloride→

Ca₅(PO₄)₃(Cl)(s) calcium chlorophosphate (chlorapatite)

Similarly, due to the Gibbs effect, Hydroxyapatite Ca₅(PO₄)₃(OH) or calcium chlorophosphate Ca₅(PO₄)₃(Cl) is very attractive for Pb, Cd, Cu, Hg, As. For example, when a heavy metal such as dissolved, free lead is exposed to Hydroxyapatite, calcium chlorophosphate, and absorption reaction would take place and bring about spontaneous reactions of substitution of calcium and precipitation and form a more stable, complex phosphate minerals with relatively lower Gibbes free energy and extremely low solubility, which are no harm to human body or ecosystem.

5Pb⁺²+Ca₅(PO₄)₃(OH)→5Ca⁺²+Pb₅(PO₄)₃(OH), Hydroxypyromorphite

5Pb⁺²+Ca₅(PO₄)₃(Cl)→5Ca⁺²+Pb₅(PO₄)₃(Cl), pyromorphite

Similarily, if the same solution contains iron ions and sulfate ions, it is easy for Hydroxypyromorphite to form an even more stable “complex lead iron phosphate mineral” (Corkite) PbFe₃(PO₄)(OH)₆SO₄ with relatively lower Gibbes free energy and extremely low solubility, having solubility Ksp at 25° C.=10^{-112.6}, which is about 10²⁸ times more stable than pyromorphite Pb₅(PO₄)₃(Cl) (solubility 10^{+84.43}).

Similarily, for heavy metal cadmium, reactions for making cadmium stable and harmless via substitution of calcium are as follows:

5Cd⁺²+Ca₅(PO₄)₃(OH)→5Ca⁺²+Cd₅(PO₄)₃(OH), cadmium hydroxyapatite

5Cd⁺²+Ca₅(PO₄)₃(Cl)→5Ca⁺²+Cd₅(PO₄)₃(Cl), cadmium chloroapatite

Similarily, for heavy metal copper, reactions for making copper stable and harmless via substitution of calcium are as follows:

5Cu⁺²+Ca₅(PO₄)₃(OH)→5Ca⁺²+Cu₅(PO₄)₃(OH), copper hydroxyapatite

5Cu⁺²+Ca₅(PO₄)₃(Cl)→5Ca⁺²+Cu₅(PO₄)₃(Cl), copper chloroapatite

For heavy metal mercury, reactions for making mercury stable and harmless via substitution of calcium due to Gibbs effect are as follows:

3Hg⁺²+calcium phosphates, including tricalcium phosphate Ca₃(PO₄)₂→3Ca⁺²+Hg₃(PO₄)₃,mercury phosphate mineral

For heavy metal arsenic, the key mechanism of reactions for making arsenic stable and harmless is mainly substitution of phosphate ions contained in Ca₅(PO₄)₃(OH) or Ca₅(PO₄)₃(Cl) with arsenate ion AsO₄⁻³ due to Gibbs effect, the reactions are as follows.

3AsO₄⁻³+Ca₅(PO₄)₃(OH)→3PO₄⁻³+Ca₅(AsO₄)₃(OH)Johnbaumite

3AsO₄⁻³+Ca₅(PO₄)₃(Cl)→3PO₄⁻³+Ca₅(AsO₄)₃(Cl)Turneaureite

The fundamental chemical reactions presented above illustrated the main reaction mechanisms how the product of the present invention reduce the leaching toxicity of heavy metals, including lead, arsenic, copper, arsenic, mercury and the like, contained in foods, foodstuffs, Chinese herbs during soaking, brewing, cooking, or seasoning and renders the heavy metals stable and harmless.

The overview of the overall reaction principle is summarized as follows:

During the processes of soaking, brewing, cooking, or seasoning, the product of the present invention is added directly to foods, foodstuffs, Chinese herbs containing water or with addition of water followed by stirring or heating to obtain an uniform mixture; the bulkiness, softness and porosity of foods, foodstuffs, Chinese herbs are increased by means of soaking, brewing, cooking itself or raw materials or ingredients with function of bulking or leavening, such as calcium hydrogen phosphate, sodium lactate, calcium carbonate, so that some soluble heavy metals hidden in the deep would leach out; heavy metals, particularly lead (Pb), and toxic chemicals will leach out from food tissues by means of food-grade salt (sodium chloride) with osmotic function, so that the solubility and mobility of heavy metals as well as the opportunities for heavy metals being captured by, contacting with, and reacting with stabilizing agents such as phosphates will be increased; chloride ions is produced from food-grade chloride; harmful substances including dissolved, free heavy metals are adsorbed and fixed by foods, foodstuffs, Chinese herbs that are riched in dietary fiber, colloid, phlegm or riched in probiotic, or thickeners; antioxidants such as sulfur compounds, ascorbic acid or ascorbate, sodium phytate, polyphenols, which has functions of reducing lead toxicity, preventing lead absorption, or strongly chelating metal ions, are used to chelate the dissolved, free heavy metal in foods, foodstuffs, Chinese herbs and reducing lead toxicity; or food-grade iron compound is used to produce iron ions; acidity regulator such as potassium hydroxide, sodium bicarbonate, calcium hydroxide to produce hydroxide ions or other acidity regulator such as sodium tripolyphosphate is used to maintain the desirable pH range of foods, foodstuffs, Chinese herbs; due to the Gibbs effect, phosphate ions contained in phosphoric acid or phosphates would be complexed with calcium ion, hydroxide ion, chloride to form complex hydroxyapatite, calcium chlorophosphate (chlorapatite), which further spontaneously reacts with dissolved, free heavy metals contained in foods, foodstuffs, Chinese herbs, and/or those adsorbed, chelated, or complexed by iron ions, dietary fiber, colloid, phlegm, probiotics, antioxidant, thickener, nutrition enhancer for substitution and precipitation to form complex phosphate minerals such as pyromorphite, corkite that are extremely insoluble, not easy to decompose, and harmless, even in the 1 N acetic acid solution with acidity strength higher than that of human stomach or extreme environment such as acid rain when foods, foodstuffs, Chinese herbs are cooked and before they enter human mouth and stomach. Also, dietary fiber, colloid, phlegm, or probiotics stimulate peristalsis of bowels, greatly reducing the time of harmful substances, carcinogens contacting with the intestinal wall, the harmful toxins and the stable complexed heavy metal would be quickly excreted. At the same time, adequate intake of nutrition enhancer, antioxidant, dietary fiber, colloid, phlegm, or probiotics would be helpful for health, including improvement of immune function with immunity enhanced, amelioration of intestinal health, prevention of cardiovascular disease, prevention of cancer, prevention of diabetes and other diseases. Suitable preservatives are also beneficial to enhance food security.

A method for preparing a stabilizing agent for reducing leaching toxicity of heavy metals contained in foods, foodstuffs, Chinese herbs and therefore enhancing food safety and environmental protection according to the present invention includes: weighting phosphoric acid or phosphate, acidity regulator, chloride accurately in a certain ratio, respectively, feeding all of them into a mixer followed by evenly mixing with stirring in the mixer at normal temperature and pressure before packaging.

Beneficial Effects

Stabilizing agent of the present invention is added directly to foods, foodstuffs, Chinese herbs, the leaching toxicity, i.e., leaching solubility of heavy metals contained in the foods, foodstuffs, Chinese herbs would be reduced during brewing, cooking, or seasoning processes, before they enter the human mouth, gastrointestinal tract or before they are discarded randomly, piled up or landfilled along with food residues or kitchen wastes, even in 1N Hydrochloric (HCl) acid solution with acid strength stronger than the human stomach acid or extreme conditions such as acid rain, heavy metals would be converted to products that are not easy to decompose, chemically inert, not easily absorbed by human body and crops, thus food safety is enhanced, and heavy metals will be much less movable, diffusive or transformable in the environment, thus environmental protection is enhanced and heavy metals are prevented from going back to the food chain. It has a great application prospect.

### DESCRIPTION OF THE EMBODIMENTS

The present invention is further illustrated with reference to the following specific examples. It should be understood that these examples are merely illustrative of the present invention and are not intended to limit the scope of the present invention. It should also be understood that various changes or modifications may be made by those skilled in the art upon reading the disclosure of the specification, these equivalents also fall within the scope of the present invention as defined by the appended claims.

### Example 1

An instant noodle with low lead (Pb) leaching toxic concentration was used as the sample of this example, and one liter (1,000 ml) of boiled pure water was prepared.

(1) An appropriate amount (such as 500 ml, i.e., 500 g) of boiled pure water mentioned above was used to brew one pack of the instant noodle with low lead (Pb) leaching toxic concentration in an empty and clean glass bottle, followed by adding seasonings attached, and stirring evenly. Then, one half of the noodle (at least 50 g) and one half of the soup were taken as sample and placed into another empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample without addition of heavy metal detoxification stabilizing agent.

(2) After one half of soup and noodle were removed from the instant noodle added with boiled pure water and seasonings for the test as described above in (1), a small amount of 0.3 g (300 mg) of a heavy metal stabilizing agent prepared (composition in mass percentage: dietary fiber foods (konjac flour) 40%, phosphates (disodium dihydrogen pyrophosphate+calcium hydrogen phosphate) 48%, acidity regulator (potassium hydroxide) 8%, sodium chloride 4%) was added and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample containing the heavy metal stabilizing agent were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample with addition of 0.3 g of the heavy metal detoxification stabilizing agent.

After testing, heavy metal lead (Pb) leaching toxic concentrations of the instant noodle samples before stabilization treatment, i.e., (1) and after stabilization treatment, i.e., (2) were listed as follows:

| | | Example 1(2) |
|---|---|---|
| | Example 1(1) | heavy metal leaching |
| | heavy metal leaching | toxic concentrations |
| | toxic concentration | with addition of 0.3 |
| | without addition of | g of the heavy metal |
| | heavy metal stabilizing | stabilizing agent |
| Test Item | agent (μg/kg) | (μg/kg) |
| lead (Pb) | 4.0 | 1.0 |

The test results showed that the lead (Pb) leaching toxic concentration of the instant noodle sample before stabilization treatment was 4 μg/kg (i.e., 4 μg/Kg or 0.004 mg/kg), after stabilization treatment, i.e., addition of 0.3 g of the heavy metal stabilizing agent as described in above Example 1(2), the lead (Pb) leaching toxic concentrations of the instant noodle sample was 1 μg/kg (i.e., or 0.001 mg/kg), that is, the leaching toxic concentration or leaching toxicity of heavy metal lead (Pb) was reduced by 75%.

### Example 2

Two packs of instant noodles with high lead (Pb) leaching toxic concentration with the same brand that purchased at the same time were used as the sample of this example, and one liter (1,000 ml) of boiled pure water was prepared.

(1) 500 ml, i.e., 500 g, of boiled water mentioned above was used to brew one of the two packs of instant noodle with high lead (Pb) leaching toxic concentration in an empty and clean glass bottle, followed by adding seasonings attached, and stirring evenly. Then, one half of the noodle (at least 50 g) and one half of the soup were taken as sample and placed them into another empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction), wherein 1N HCl used as leaching agent (to simulate gastric acid but its acidic strength is stronger than gastric acid) and the noodle and soup sample were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample without addition of heavy metal detoxification stabilizing agent.

(2) After one half of soup and noodle were removed from the instant noodle added with boiled pure water and seasonings for the test as described above in (1), 1.0 g (1,000 mg) of a heavy metal stabilizing agent prepared (composition in mass percentage: dietary fiber foods (mushroom power) 60%, phosphate ((disodium hydrogen phosphate+sodium dihydrogen phosphate) 8%, acidity regulator (sodium carbonate) 20%, nutrition enhancer (calcium carbonate) 8%, sodium chloride 4%) was added to the remaining half of brewed noodle and soup in the same bottle, and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample containing the heavy metal stabilizing agent were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample with addition of 1.0 g of the heavy metal detoxification stabilizing agent.

(3) The other pack of instant noodle with high lead (Pb) level was placed into an empty and clean glass bottle followed by adding 500 ml, i.e., 500 g, of boiled pure water and seasonings attached, and stirring evenly. Afterwards, one half of the noodle (at least 50 g) and one half of the soup were taken as sample and placed them into another empty and clean glass bottle, followed by adding 1.0 g (1,000 mg) of a heavy metal stabilizing agent prepared (composition in mass percentage: dietary fiber foods (mushroom power) 44%, phosphate ((disodium hydrogen phosphate+sodium dihydrogen phosphate) 8%, acidity regulator (sodium carbonate) 20%, nutrition enhancer (calcium carbonate) 8%, chloride 20%), and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample containing the heavy metal stabilizing agent were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of leachate of sample with addition of 1.0 g of the heavy metal detoxification stabilizing agent.

After testing, the heavy metal lead (Pb) leaching toxic concentrations of the instant noodle samples with high lead (Pb) level before stabilization treatment, i.e., (1) and after stabilization treatment, i.e., (2) and (3) were listed as follows:

| | | Example 2(2) | Example 2(3) |
|---|---|---|---|
| | Example 2(1) | heavy metal leaching | heavy metal leaching |
| | heavy metal leaching | toxic concentration | toxic concentration |
| | toxic concentration | with addition of 1.0 | with addition of 1.0 |
| | without addition of | g of the heavy metal | g of the heavy metal |
| | heavy metal stabilizing | stabilizing agent in | stabilizing agent in |
| Test Item | agent (mg/kg) | (2)(mg/kg) | (3)(mg/kg) |
| lead (Pb) | 0.031 | 0.019 | 0.005 |

The test results showed that the lead (Pb) leaching toxic concentration of the instant noodle sample before stabilization treatment described in (1) was 0.031 mg/kg (i.e., 31 μg/Kg), after stabilization treatment on the same pack described in (2), i.e., addition of 1.0 g of the heavy metal stabilizing agent as described in above Example 2(2), the lead (Pb) leaching toxic concentration was 0.019 mg/kg (i.e., 19 μg/Kg), that is, the leaching toxicity of heavy metal lead (Pb) was reduced by approximately 38%. In (3), after 1.0 g of the heavy metal stabilizing agent in Example 2(3) was added, the lead (Pb) leaching toxic concentration became 0.005 mg/kg (i.e., 5 μg/Kg), that is, the leaching toxicity of heavy metal lead (Pb) was reduced by about 84%, as compared to 31 μg/Kg, the lead (Pb) leaching toxic concentration before stabilization treatment of the instant noodle with the same brand and purchased at the same time and used in the test (1). Example 2 also showed that the more sodium chloride used in the heavy metal stabilizing agent, the more in decrease of heavy metal lead (Pb) leaching toxic concentration.

### Example 3

One packet of instant noodles containing high lead (Pb) leaching toxic concentration with the same brand and purchased at the same time as those used for Example 2 was used as the sample of this example, and one liter (1,000 ml) of boiled pure water was prepared.

(1) 500 ml, i.e., 500 g, of boiled water mentioned above was used to brew one packet of instant noodle with high lead (Pb) level with the same brand and purchased at the same time as those used for Example 2 in an empty and clean glass bottle followed by adding seasonings attached, and stirring evenly. Afterwards, one half of the noodle (at least 50 g) and one half of the soup were taken as sample and placed into another empty and clean glass bottle, into which 0.5 g (500 mg) of a heavy metal stabilizing agent that was identical to that used in Examples 1(2)(composition in mass percentage: dietary fiber foods (konjac flour) 40%, phosphate (disodium dihydrogen pyrophosphate+calcium hydrogen phosphate) 48%, acidity regulator (potassium hydroxide) 8%, sodium chloride 4%) was added and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample containing the heavy metal stabilizing agent were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample with addition of 0.5 g of the heavy metal detoxification stabilizing agent.

(2) After one half of soup and noodle were removed from the instant noodle with low lead (Pb) leaching toxic concentration added with boiled pure water and seasonings for the test as described above in (1), 1.0 g (1000 mg) of a heavy metal stabilizing agent that was identical to that used in Example 1(2) and Example 3(1) (composition in mass percentage: dietary fiber foods (konjac flour) 40%, phosphate (disodium dihydrogen pyrophosphate+calcium hydrogen phosphate) 48%, acidity regulator (potassium hydroxide) 8%, sodium chloride 4%) was added to the remaining half of brewed noodle soup in the same bottle and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample containing the heavy metal stabilizing agent were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample with addition of 1.0 g of the heavy metal detoxification stabilizing agent.

After testing, the heavy metal lead (Pb) leaching toxic concentrations of the instant noodle samples before stabilization treatment, i.e., Example 3(1) and after stabilization treatment, i.e., Example 3 (2) were listed as follows:

| | | Example 3(1) | Example 3(2) |
|---|---|---|---|
| | | heavy metal leaching | heavy metal leaching |
| | Example 2(1) | toxic concentration | toxic concentration |
| | heavy metal leaching | with addition of 0.5 | with addition of 1.0 |
| | toxic concentration | g of the heavy metal | g of the heavy metal |
| | without addition of | stabilizing agent as | stabilizing agent as |
| | heavy metal stabilizing | described in the | described in the |
| Test Item | agent (μg/kg) | (1) (μg/kg) | (2) (μg/kg) |
| lead (Pb) | 31 | 1.0 | <1.0 |

The test results showed that as compared to 31 μg/Kg, the lead (Pb) leaching toxic concentration before stabilization treatment of the instant noodle with the same brand and purchased at the same time as those used in Example 2, the lead (Pb) leaching toxic concentration of the instant noodle sample after stabilization treatment, i.e., addition of 0.5 g of the heavy metal stabilizing agent as described in above Example 3(1), was 1 μg/kg, the leaching toxicity of heavy metal lead (Pb) was reduced by about 96%. In Example 3(2), after 1.0 g of the same heavy metal stabilizing agent was added, the lead (Pb) leaching toxic concentration of the instant noodle sample became <1 μg/kg*, the leaching toxicity of heavy metal lead (Pb) was reduced by more than 96%. *the detection limit of lead (Pb) of graphite furnace atomic absorption spectrometry is 1 μg/kg (i.e., the concentration lower than 1 μg/kg cannot be accurately determined). Example 3 also showed that the more heavy metal stabilizing agent, the more in decrease of heavy metal leaching toxic concentration. As showed by comparison between Example 3 and Example 2(2), the more phosphates added, the more in decrease of heavy metal leaching toxic concentration.

### Example 4

Two packs of instant noodle with high arsenic (As) leaching toxic concentration with the same brand that purchased at the same time were used as the sample of this example, and one liter (1,000 ml) of boiled pure water was prepared.

(1) 500 ml, i.e., 500 g, of boiled water mentioned above was used to brew one of the two packs of instant noodle with high arsenic (As) leaching toxic concentration in an empty and clean glass bottle, followed by adding seasonings attached, and stirring evenly. Then, one half of the noodle (at least 50 g) and one half of the soup were taken as sample and placed into another empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration of the leachate of sample without addition of heavy metal detoxification stabilizing agent.

(2) After one half of soup and noodle were removed from the instant noodle and seasonings added with boiled pure water for the test as described above in (1), 1.0 g of a heavy metal stabilizing agent prepared (composition in mass percentage: dietary fiber foods (pepper powder) 67%, phosphate ((calcium hydrogen phosphate+tricalcium phosphate) 20%, acidity regulator (sodium bicarbonate) 4%, nutrition enhancer (calcium carbonate) 5%, sodium chloride 4%) was added to the remaining half of brewed noodle and soup in the same bottle, and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample were vibrated in an extraction bottle for 24 hours (longer extraction time), the rest procedures of the HJ/T299-2007method remained unchanged. After filtration, a hydride generator atomic absorption spectrometry was used to determine the arsenic (As) leaching toxic concentration of the leachate of sample with addition of 1.0 g of the heavy metal detoxification stabilizing agent.

(3) The other pack of instant noodle with high arsenic (As) level was placed into an empty and clean glass bottle followed by adding 500 ml, i.e., 500 g, of boiled pure water and seasonings attached and stirring evenly. Afterwards, one half of the noodle (at least 50 g) and one half of the soup were taken as sample and placed them into another empty and clean glass bottle, followed by adding 1.0 g (1,000 mg) of a heavy metal stabilizing agent prepared (composition in mass percentage: dietary fiber foods (pepper powder) 43%, phosphate ((calcium hydrogen phosphate+tricalcium phosphate) 20%, acidity regulator (sodium bicarbonate) 16%, nutrition enhancer (calcium carbonate) 5%, sodium chloride 16%), and stirred evenly, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the noodle and soup sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration of the leachate of sample with addition of 1.0 g of the heavy metal detoxification stabilizing agent.

After testing, the heavy metal arsenic (As) leaching toxic concentrations of the instant noodle samples with high arsenic (As) level before stabilization treatment, i.e., (1) and after stabilization treatment, i.e., (2) and (3) were listed as follows:

| | | Example 4(2) | Example 4(3) |
|---|---|---|---|
| | | heavy metal leaching | heavy metal leaching |
| | Example 4(1) | toxic concentration | toxic concentration |
| | heavy metal leaching | with addition of 1.0 | with addition of 1.0 |
| | toxic concentration | g of the heavy metal | g of the heavy metal |
| | without addition of | stabilizing agent as | stabilizing agent as |
| | heavy metal stabilizing | described in | described in |
| Test Item | agent (mg/kg) | (2) (mg/kg) | (3) (mg/kg) |
| arsenic (As) | 0.142 | 0.081 | 0.011 |

The test results showed that the arsenic (As) leaching toxic concentration of the instant noodle sample before stabilization treatment was 0.142 mg/kg (i.e., 142 μg/Kg), after stabilization treatment, i.e., addition of 1.0 g of the heavy metal stabilizing agent as described in Example 4(2), the arsenic (As) leaching toxic concentrations was 0.081 mg/kg (i.e., 81 μg/Kg), that is, the leaching toxic concentration or leaching toxicity of heavy metal arsenic (As) was reduced by 42.96%, about 43%. In Example 4(3), after the noodle and soup was treated with 1.0 g of the heavy metal stabilizing agent, the arsenic (As) leaching toxic concentration became 0.011 mg/kg (i.e., 11 μg/Kg), that is, the leaching toxicity of heavy metal arsenic (As) was reduced by about 92% as compared to 0.142 mg/kg, the arsenic (As) leaching toxic concentration before stabilization treatment of the instant noodle with the same brand and purchased at the same time and used in Example 4(1). Example 4 also showed that the more sodium chloride and acidity regulator (sodium bicarbonate) employed in the heavy metal stabilizing agent, the more in reduction of the heavy metal arsenic (As) leaching toxic concentration.

### Example 5

About 500 g rice with arsenic (As) leaching toxic concentration was used as the sample of this example, and all rice was washed with pure water firstly.

(1) To 175 g of the washed rice contaminated with arsenic (As) as described above was added an appropriate amount of pure water according to a conventional ratio (for example, rice:water ratio of 1:1), then, the mixture was placed into an electric cooker to cook. After the cooking was done, let the rice cool down for more than ten (10+) minutes, then at least 250 g of rice was taken and placed in an empty and clean glass bottle, then the bottle was covered and send to a lab for analysis. HJ/T299-2007 solid waste leaching toxicity test was conduct on the sample according to GB5085.3-2007(Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration of the leachate of sample without addition of heavy metal detoxification stabilizing agent.

(2) To 175 g of the rice contaminated with arsenic (As), which was from the same bag and washed together with that used in the test (1) was add 5.0 g of a heavy metal stabilizing agent (composition in mass percentage: dietary fiber foods (pumpkin powder) 76%, phosphate (disodium hydrogen phosphate+sodium dihydrogen phosphate+calcium hydrogen phosphate+tricalcium phosphate) 13%, acidity regulator (sodium bicarbonate) 4%, sodium chloride 3%, magnesium chloride 2%, and preservative (ε-polylysine) 2%). Afterwards, the same amount of pure water as used in test (1) was added and stirred evenly, and then the mixture was placed into an electric cooker to cook. After the cooking was done, let the rice cool down for more than ten (10+) minutes, then at least 250 g of rice was taken and placed into an empty and clean glass bottle, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration of the leachate of sample with addition of heavy metal detoxification stabilizing agent.

After testing, the heavy metal arsenic (As) leaching toxic concentrations of the rice samples before stabilization treatment, i.e., (1) and after stabilization treatment, i.e., (2) were listed as follows:

| | | Example 5 (2) |
|---|---|---|
| | Example 5 (1) | heavy metal leaching |
| | heavy metal leaching | toxic concentrations |
| | toxic concentration | with addition of 5.0 |
| | without addition of | g of the heavy metal |
| | heavy metal stabilizing | stabilizing agent |
| Test Item | agent (mg/kg) | (mg/kg) |
| arsenic (As) | 0.136 | 0.007 |

The test results showed that the arsenic (As) leaching toxic concentration of the cooked, arsenic contaminated rice before stabilization treatment was 0.136 mg/kg (i.e., 136 μg/Kg), after stabilization treatment, i.e., addition of 5.0 g of the heavy metal stabilizing agent as described in above Example 5(2) to 175 g of rice, the arsenic (As) leaching toxic concentration of the cooked rice was 0.007 mg/kg (i.e., 7 μg/Kg), that is, the leaching toxic concentration of heavy metal arsenic (As) of the rice contaminated with arsenic was decreased or the leaching toxicity of heavy metal arsenic (As) was reduced by about 95%.

### Example 6

About 500 g rice with cadmium (Cd) leaching toxic was used as the sample of this example, and all rice was washed with pure water firstly.

(1) To 175 g of the washed rice contaminated with cadmium (Cd) as described above was added 175 g pure water (rice:water ratio of 1:1), then the mixture was placed into an electric cooker to cook. After the cooking was done, let the rice cool down for more than ten (10+) minutes, then at least 250 g of rice was taken and placed in an empty and clean glass bottle, then the bottle was covered and send to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a graphite furnace atomic absorption spectrometry was used to determine the cadmium (Cd) leaching toxic concentration of the leachate of sample without addition of heavy metal detoxification stabilizing agent.

(2) To 175 g of the rice contaminated with cadmium (Cd), which was from the same bag and washed together with that used in the test (1) was added 5.0 g of a heavy metal stabilizing agent (composition in mass percentage: dietary fiber foods (pumpkin powder) 78%, phosphate (disodium hydrogen phosphate+sodium dihydrogen phosphate+calcium hydrogen phosphate+tricalcium phosphate) 13%, acidity regulator (sodium bicarbonate) 4%, sodium chloride 3%, and magnesium chloride 2%). Afterwards, 175 g pure water (rice:water ratio of 1:1) was added and stirred evenly, then the mixture was placed into an electric cooker to cook. After the cooking was done, let the rice cool down for more than ten (10+) minutes, then at least 250 g of rice was taken and placed in an empty and clean glass bottle, and then the bottle was covered and send to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a graphite furnace atomic absorption spectrometry was used to determine the cadmium (Cd) leaching toxic concentration of the leachate of sample with addition of heavy metal detoxification stabilizing agent.

After testing, the heavy metal cadmium (Cd) leaching toxic concentrations of the rice samples before stabilization treatment, i.e., (1) and after stabilization treatment, i.e., (2) were listed as follows:

| | | Example 6(2) |
|---|---|---|
| | Example 6(1) | heavy metal leaching |
| | heavy metal leaching | toxic concentrations |
| | toxic concentrations | with addition of 5.0 |
| | without addition of | g of the heavy metal |
| | heavy metal stabilizing | stabilizing agent |
| Test Item | agent (μg/kg) | (μg/kg) |
| cadmium (Cd) | 5.4 | 1.0 |

The test results showed that the cadmium (Cd) leaching toxic concentration of the cooked rice before stabilization treatment was 5.4 μg/Kg, after stabilization treatment, i.e., addition of 5.0 g of the heavy metal stabilizing agent as described in above Example 6(2) to 175 g of rice, the cadmium (Cd) leaching toxic concentration of the cooked rice was 1.0 μg/Kg), that is, the leaching toxic concentration of heavy metal cadmium (Cd) of the rice contaminated with cadmium was decreased or the leaching toxicity of heavy metal cadmium (Cd) was reduced by about 81%.

### Example 7

About 500 g brown rice with lead (Pb) leaching toxic was used as the sample of this example, and all rice was washed with pure water firstly.

(1) To 175 g of the washed brown rice contaminated with lead (Pb) as described above was added 175 g pure water (rice:water ratio of 1:1), then the mixture was placed into an electric cooker to cook. After the cooking was done, let the rice cool down for more than ten (10+) minutes, then at least 250 g of rice was taken and placed into an empty and clean glass bottle, and the bottle was covered and send to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample without addition of heavy metal detoxification stabilizing agent.

(2) To 175 g of the brown rice contaminated with lead (Pb), which was from the same bag and washed together with that used in the test (1) was added 5.0 g of a heavy metal stabilizing agent (composition in mass percentage: phosphate (disodium hydrogen phosphate+sodium dihydrogen phosphate+calcium hydrogen phosphate) 80%, acidity regulator (calcium hydroxide) 10%, sodium chloride 7%, and magnesium chloride 3%). Afterwards, the same amount (175 g) of pure water as used in the test (1) was added and stirred evenly, and then the mixture was placed into an electric cooker to cook. After the cooking was done, let the rice cool down for more than ten (10+) minutes, then at least 250 g of rice was taken and placed into an empty and clean glass bottle, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a graphite furnace atomic absorption spectrometry was used to determine the lead (Pb) leaching toxic concentration of the leachate of sample with addition of heavy metal detoxification stabilizing agent.

After testing, the heavy metal lead (Pb) leaching toxic concentrations of the brown rice samples before stabilization treatment, i.e., (1) and after stabilization treatment, i.e., (2) were listed as follows:

| | | Example 7(2) |
|---|---|---|
| | Example 7(1) | heavy metal leaching |
| | heavy metal leaching | toxic concentration |
| | toxic concentration | with addition of 5.0 |
| | without addition of | g of the heavy metal |
| | heavy metal stabilizing | stabilizing agent |
| Test Item | agent (μg/kg) | (μg/kg) |
| lead (Pb) | 10 | <1 |

The test results showed that the lead (Pb) leaching toxic concentration of the cooked brown rice containing lead before stabilization treatment was 0.010 mg/kg (i.e., 10 μg/Kg), after stabilization treatment, i.e., addition of 5.0 g of the heavy metal stabilizing agent as described in above Example 7(2) to 175 g of brown rice, the lead (Pb) leaching toxic concentration of the cooked brown rice was <0.001 mg/kg (i.e., <1 μg/Kg*), that is, the lead (Pb) leaching toxic concentration or toxicity of the brown rice contaminated with lead was reduced by 90%. *the detection limit of lead (Pb) of graphite furnace atomic absorption spectrometry is 1 μg/kg (i.e., the concentration lower than 1 μg/kg cannot be accurately determined).

### Example 8

About 500 g rice containing arsenic (As) and lead (Pb) leaching toxic was used as the sample of this example, and all rice was washed with pure water firstly.

(1) To 175 g of the washed rice contaminated with arsenic (As) and lead (Pb) as described above was added 175 g pure water (rice:water ratio of 1:1), then the mixture was placed into an electric cooker to cook. After the cooking was done, let the rice cool down for more than ten (10+) minutes, then at least 250 g of rice was taken and placed into an empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration and a graphite furnace atomic absorption spectrometry was used to determine the lead (Pb) leaching toxic concentration of the leachate of sample without addition of heavy metal detoxification stabilizing agent.

(2) To 175 g of the rice contaminated with arsenic (As) and lead (Pb), which was from the same bag and washed together with that used in the test (1), was added 10.0 g of a heavy metal stabilizing agent (composition in mass percentage: dietary fiber foods (Coix Seed powder) 60%, phosphate (calcium hydrogen phosphate+tricalcium phosphate) 18%, acidity regulator (calcium hydroxide) 10%, sodium chloride 10%, thickener (soluble soybean polysaccharide) 1%, antioxidant (ascorbic acid) 1%). Afterwards, the same amount (175 g) of pure water was added and stirred evenly, and then the mixture was placed into an electric cooker to cook. After the cooking is done, let the rice cool down for more than ten (10+) minutes, then at least 250 g of rice was taken and placed into an empty and clean glass bottle, then the bottle was covered and sent to a lab for analysis. HJ/T299-2007 solid waste leaching toxicity test was conducted on the sample according to GB5085.3-2007 (Identification standards for hazardous wastes-Identification for extraction toxicity), wherein 1N HCl used as leaching agent (to simulate gastric acid but its acidic strength is stronger than gastric acid) and the rice sample were vibrated in an extraction bottle for 24 hours (longer extraction time), the rest procedures of the HJ/T299-2007 method remained unchanged. After filtration, a hydride generator atomic absorption spectrometry was used to determine the arsenic (As) leaching toxic concentration and a graphite furnace atomic absorption spectrometry was used to determine the lead (Pb) leaching toxic concentration of the leachate of sample with addition of heavy metal detoxification stabilizing agent.

After testing, the heavy metal arsenic (As) and lead (Pb) leaching toxic concentrations of the rice samples before stabilization treatment, i.e., (1) and after stabilization treatment, i.e., (2) were listed as follows:

| | | Example 8(2) |
|---|---|---|
| | Example 8(1) | heavy metal leaching |
| | heavy metal leaching | toxic concentration |
| | toxic concentration | with addition of 10.0 |
| | without addition of | g of the heavy metal |
| | heavy metal stabilizing | stabilizing agent |
| Test Item | agent (mg/kg) | (mg/kg) |
| lead (Pb) | 0.00134 | <0.001 |
| arsenic (As) | 0.126 | <0.001 |

The test results showed that the arsenic (As) leaching toxic concentration of the cooked rice contaminated with arsenic (As) and lead (Pb) before stabilization treatment was 0.126 mg/kg (i.e., 126 μg/Kg), while the lead (Pb) leaching toxic concentration was 0.00134 mg/kg (i.e., 1.34 μg/Kg), after stabilization treatment, i.e., addition of 10.0 g of the heavy metal stabilizing agent as described in above Example 8(2) to 175 g of rice contaminated with arsenic (As) and lead (Pb), the arsenic (As) leaching toxic concentration of the cooked rice was <0.001 mg/kg (i.e., <1 1 μg/Kg*), that is, the leaching toxic concentration of heavy metal arsenic (As) of the rice contaminated with arsenic was reduced by >99%; the lead (Pb) leaching toxic concentration of the cooked rice is <0.001 mg/kg (i.e., <1 1 μg/Kg*). *Both the detection limit of lead (Pb) and the detection limit of arsenic (As) of graphite furnace atomic absorption spectrometry are 1 μg/kg (i.e., the concentration lower than 1 μg/kg cannot be accurately determined).

### Example 9

About 600 g oysters containing cadmium and copper (Cd, Cu) leaching toxic was used as the sample of this example, and all oysters were washed with pure water firstly.

(1) 250 g of the washed oysters were taken as sample and placed into an empty and clean glass bottle, then the bottle was covered and send to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the oyster sample were vibrated in an extraction bottle for 24 hours (longer extraction time), the rest procedures of the HJ/T299-2007 method remained unchanged. After filtration, a graphite furnace atomic absorption spectrometry was used to determine the cadmium and copper (Cd, Cu) leaching toxic concentrations of the leachate of sample without addition of heavy metal stabilizing agent.

(2) 250 g oysters were taken as sample, which were from the same bag and washed together with those used in test (1), to which was added 5.0 g of a heavy metal stabilizing agent (composition in mass percentage: phosphate (sodium hexametaphosphate) 85%, acidity regulator (calcium hydroxide+sodium bicarbonate) 12%, sodium chloride 3%), and stirred evenly, and then placed into an empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the oyster sample were vibrated in an extraction bottle for 24 hours (longer extraction time), the rest procedures of the HJ/T299-2007 method remain unchanged. After filtration, a graphite furnace atomic absorption spectrometry was used to determine the cadmium and copper (Cd, Cu) leaching toxic concentrations of the leachate of sample with addition of 5.0 g of the heavy metal stabilizing agent.

After testing, the heavy metal cadmium and copper (Cd, Cu) leaching toxic concentrations of the oyster sample before stabilization treatment, i.e., (1) and after stabilization treatment, i.e., (2) were listed as follows:

| | | Example 9(2) |
|---|---|---|
| | Example 9(1) | heavy metal leaching |
| | heavy metal leaching | toxic concentrations |
| | toxic concentrations | with addition of 10.0 |
| | without addition of | g of the heavy metal |
| | heavy metal stabilizing | stabilizing agent |
| Test Item | agent (mg/kg) | (mg/kg) |
| cadmium (Cd) | 0.226 | 0.010 |
| copper(Cu) | 31.0 | 20.5 |

The test results showed that the cadmium (Cd) leaching toxic concentration of the oyster sample before stabilization treatment was 0.226 mg/kg, after stabilization treatment, i.e., addition of 5.0 g of the heavy metal stabilizing agent as described in above Example 9(2), the cadmium (Cd) leaching toxic concentration of the oyster sample was 0.010 mg/kg, that is, the leaching toxic concentration of heavy metal cadmium (Cd) of the oyster sample was reduced by about 95%. The copper (Cu) leaching toxic concentration of the oyster sample before stabilization treatment was 31.0 mg/kg, while the copper (Cu) leaching toxic concentration of the oyster sample after stabilization treatment was 20.5 mg/kg, that is, the leaching toxic concentrations of copper (Cu) of the 250 g of oyster sample with addition of 10.0 g of the heavy metal stabilizing agent was decreased by about 30% at the same time.

### Example 10

About 600 g of Chinese herb angelica sinensis (Danggui) head with mercury (Hg) leaching toxic was used as the sample of this example, and all angelica sinensis head were washed together with pure water firstly.

(1) 500 g of the washed angelica sinensis head were taken as sample, sliced first and then placed in a pot, and appropriate amount of pure water was added and boiled, then cooled down for more than ten (10+) minutes, one half of the angelica sinensis head (about 250 g) and one half of the soup were taken as sample, and placed into an empty and clean glass bottle, and then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the angelica sinensis head sample were vibrated in an extraction bottle for 24 hours (longer extraction time), the rest procedures of the HJ/T299-2007 method remained unchanged. After filtration, a hydride generator atomic absorption spectrometry was used to determine the mercury (Hg) leaching toxic concentration of the leachate of sample without addition of heavy metal detoxification stabilizing agent.

(2) After one half of angelica sinensis head and one half of soup was removed for the test in (1), the remaining half of angelica sinensis head and half of soup in the same pot was placed into another empty and clean glass bottle, to which was added 2.0 g of the heavy metal stabilizing agent (composition in mass percentage: phosphate (tricalcium phosphate+calcium hydrogen phosphate) 90%, acidity regulator (sodium carbonate) 7%, sodium chloride 3%) and stirred evenly, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the angelica sinensis head sample were vibrated in an extraction bottle for 24 hours (longer extraction time), the rest procedures of the HJ/T299-2007 method remain unchanged. After filtration, a hydride generator atomic absorption spectrometry was used to determine the mercury (Hg) leaching toxic concentration of the leachate of sample with addition of 2.0 g of the heavy metal stabilizing agent.

After testing, the mercury (Hg) leaching toxic concentrations of the angelica sinensis head samples before stabilization treatment, i.e., (1) and after stabilization treatment, i.e., (2) were listed as follows:

| | | Example10(2) |
|---|---|---|
| | Example 10 (1) | heavy metal leaching |
| | heavy metal leaching | toxic concentrations |
| | toxic concentrations | with addition of 2.0 |
| | without addition of | g of the heavy metal |
| | heavy metal stabilizing | stabilizing agent |
| Test Item | agent (μg/kg) | (μg/kg) |
| Mercury (Hg) | 0.8 | 0.3 |

The test results showed that the mercury (Hg) leaching toxic concentration of boiled angelica sinensis head before stabilization treatment was 0.8 μg/kg, after stabilization treatment, i.e., addition of 2.0 g of the heavy metal stabilizing agent as described in above Example 10(2) to about 250 g of boiled angelica sinensis head, the mercury (Hg) leaching toxic concentration of the angelica sinensis head sample was 0.3 μg/kg), that is, the mercury (Hg) leaching toxicity of the angelica sinensis head sample was decreased by about 62%.

### Example 11

About 800 g Chinese herb angelica sinensis (Danggui) head with cadmium (Cd) leaching toxic was used as the sample of this example, and all angelica sinensis heads were washed together with pure water firstly.

(1) 600 g of the washed angelica sinensis head was taken as sample, sliced first and then placed in a pot, and appropriate amount of pure water was added and boiled, then cooled down for more than ten (10+) minutes, then ⅓ of the angelica sinensis head (about 200 g) and ⅓ of the soup were taken as sample, and placed into an empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the angelica sinensis head sample were vibrated in an extraction bottle for 24 hours (longer extraction time), the rest procedures of the HJ/T299-2007 method remained unchanged. After filtration, graphite furnace atomic absorption spectrometry was used to determine the cadmium (Cd) leaching toxic concentration of the leachate of sample without addition of heavy metal detoxification stabilizing agent.

(2) After ⅓ of angelica sinensis head and ⅓ of soup was removed for the test in (1), half of the remaining angelica sinensis head and soup, i.e. containing about 200 g boiled angelica sinensis head and half of the remaining soup (⅓ of soup), was taken as sample and placed into another empty and clean glass bottle, to which was added 5.0 g of a heavy metal stabilizing agent (composition in mass percentage: dietary fiber foods (mushroom powder) 20%, phosphate (tricalcium phosphate) 16%, acidity regulator (Sodium bicarbonate+sodium tripolyphosphate+sodium lactate) 60%, sodium chloride 4%) and stirred evenly, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the angelica sinensis head sample were vibrated in an extraction bottle for 24 hours (longer extraction time), the rest procedures of the HJ/T299-2007 method remained unchanged. After filtration, a graphite furnace atomic absorption spectrometry was used to determine the cadmium (Cd) leaching toxic concentration from the leachate of sample with addition of 5.0 g of the heavy metal stabilizing agent.

(3) After ⅔ of angelica sinensis head and soup was removed for the tests in (1) and (2), the remaining angelica sinensis head and soup containing about 200 g boiled angelica sinensis head was placed into another empty and clean glass bottle, to which was added 5.0 g of pure mushroom powder that was the same as that used in heavy metal stabilizing agent in (2) and stirred evenly, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the angelica sinensis head sample were vibrated in an extraction bottle for 24 hours (longer extraction time), the rest procedures of the HJ/T299-2007 method remained unchanged. After filtration, a graphite furnace atomic absorption spectrometry was used to determine the cadmium (Cd) leaching toxic concentration of the leachate of sample with addition of only 5.0 g of pure mushroom powder.

After testing, the cadmium (Cd) leaching toxic concentrations of the angelica sinensis head samples before stabilization treatment, i.e., (1), after stabilization treatment, i.e., (2), and (3) angelica sinensis head samples with addition of only pure mushroom powder were listed as follows:

| | | Example 11(2) | |
|---|---|---|---|
| | Example 11(1) | heavy metal leaching | Example 11(3) |
| | heavy metal leaching | toxic concentration | heavy metal leaching |
| | toxic concentration | with addition of 5.0 | toxic concentration |
| | without addition of | g of the heavy metal | with addition of 5.0 |
| | heavy metal stabilizing | stabilizing agent | g of pure mushroom |
| Test Item | agent (μg/kg) | (μg/kg) | powder (μg/kg) |
| cadmium (Cd) | 1.3 | 0.7 | 1.3 |

The test results showed that the cadmium (Cd) leaching toxic concentrations of boiled angelica sinensis head sample before stabilization treatment was 1.3 μg/kg, after stabilization treatment, the cadmium (Cd) leaching toxic concentration of the angelica sinensis head sample was 0.7 μg/kg), that is, the cadmium (Cd) leaching toxicity of the angelica sinensis head sample with addition of 5.0 g of the heavy metal stabilizing agent as described in above Example 11(2) was reduced by about 46%. However, the cadmium (Cd) leaching toxic concentration of angelica sinensis head with addition of only pure mushroom powder and no phosphate or acidity regulator remained unchanged, still the same as that before stabilization treatment. Example 11 also indicates that the use of dietary fiber foods, such as pure mushroom powder, but without addition of heavy metal stabilizing agent, shows no effect of reducing heavy metal leaching toxic concentration.

### Example 12

About 600 g yam containing lead and copper (Pb, Cu) leaching toxic was used as the sample of this example, and all yams were washed together with pure water firstly.

(1) 500 g of the washed yam was taken as sample, sliced first and then placed in a pot, and appropriate amount of pure water was added and boiled, then ½ of yam and one half of soup was taken as sample and cooled down for more than ten (10+) minutes, then placed into an empty and clean glass bottle, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl used as leaching agent (to simulate gastric acid but its acidic strength is stronger than gastric acid) and the yam sample was vibrated in an extraction bottle for 24 hours (longer extraction time), the rest procedures of the HJ/T299-2007 method remained unchanged. After filtration, a graphite furnace atomic absorption spectrometry was used to determine the lead and copper (Pb, Cu) leaching toxic concentrations of the leachate of sample without addition of heavy metal detoxification stabilizing agent.

(2) After half of yam and half of soup was removed for the test in (1), the remaining half of yam and soup were placed into another empty and clean glass bottle, to which was added 5.0 g of a heavy metal stabilizing agent (composition in mass percentage: phosphate (Disodium hydrogen phosphate+sodium dihydrogen phosphate+calcium hydrogen phosphate) 60%, acidity regulator (sodium bicarbonate) 35%, sodium chloride 5%) and stirred evenly, then the bottle was covered and sent to a lab for analysis. HJ/T299-2007 solid waste leaching toxicity test was conduct on the sample according to GB5085.3-2007 (Identification standards for hazardous wastes-Identification for extraction toxicity), wherein 1N HCl was used as leaching agent (to simulate gastric acid but its acidic strength is stronger than gastric acid) and the yam sample were vibrated in an extraction bottle for 24 hours (longer extraction time), the rest procedures of the HJ/T299-2007 method remained unchanged. After filtration, a graphite furnace atomic absorption spectrometry was used to determine the lead and copper (Pb, Cu) leaching toxic concentrations of the leachate of sample with addition of 5.0 g of the heavy metal stabilizing agent.

After testing, the lead and copper (Pb, Cu) leaching toxic concentrations of the yam samples before stabilization treatment, i.e., (1) and after stabilization treatment, i.e., (2) were listed as follows:

| | Example 12(1) | Example12(2) |
|---|---|---|
| | heavy metal leaching | heavy metal leaching |
| | toxic concentrations | toxic concentrations |
| | without addition of | with addition of 5.0 |
| | heavy metal stabilizing | g of the heavy metal |
| Test Item | agent (mg/kg) | stabilizing agent(mg/kg) |
| Lead (Pb) | 0.12 | 0.004 |
| Copper (Cu) | 2.42 | 1.28 |

The test results showed that the Lead (Pb) leaching toxic concentration of the yam sample before stabilization treatment was 0.012 mg/kg (i.e., 12 μg/Kg), after stabilization treatment, the Lead (Pb) leaching toxic concentration of the yam sample was 4 μg/Kg, that is, the leaching toxic concentrations of heavy metal Lead (Pb) of the yam with addition of 5.0 g of the heavy metal stabilizing agent as described in above Example 12(2) was reduced by about 67%. The copper (Cu) leaching toxic concentration of the yam before stabilization treatment was 2.42 mg/kg, the copper (Cu) leaching toxic concentration of the yam after stabilization treatment was 1.28 mg/kg, that is, the leaching toxicity of copper (Cu) of 250 g of yam with addition of 5.0 g of the heavy metal stabilizing agent was decreased by about 47% at the same time.

1. A stabilizing agent for reducing the leaching toxicity of heavy metals contained in foods, foodstuffs, Chinese herbs and enhancing food safety and environmental protection, wherein raw materials of the stabilizing agent are consisted of a phosphoric acid or phosphate, an acidity regulator, and a chloride.

2. The stabilizing agent for reducing the leaching toxicity of heavy metals contained in foods, foodstuffs, Chinese herbs and enhancing food safety and environmental protection according to claim 1, wherein the phosphate is one or more selected from tricalcium phosphate, calcium dihydrogen phosphate, calcium hydrogen phosphate, sodium pyrophosphate, sodium hexametaphosphate, sodium trimetaphosphate, sodium tripolyphosphate, trisodium phosphate, tripotassium phosphate, sodium dihydrogen phosphate, potassium dihydrogen phosphate, disodium hydrogen phosphate, dipotassium hydrogen phosphate, disodium dihydrogen pyrophosphate, ammonium dihydrogen phosphate, diammonium hydrogen phosphate, tetrapotassium pyrophosphate, trisodium hydrogen pyrophosphate, potassium polymetaphosphate, calcium acid pyrophosphate, sodium aluminum acid phosphate, magnesium hydrogen phosphate, calcium glycerophosphate, ferric pyrophosphate, casein phosphopeptide, and phosphate-containing food.

3. The stabilizing agent for reducing the leaching toxicity of heavy metals contained in foods, foodstuffs, Chinese herbs and enhancing food safety and environmental protection according to claim 2, wherein the phosphate-containing food is one or more selected from bone meal, bone bouillon extract powder, and fish meal.

4. The stabilizing agent for reducing the leaching toxicity of heavy metals contained in foods, foodstuffs, Chinese herbs and enhancing food safety and environmental protection according to claim 1, wherein the acidity regulator is one or more selected from tricalcium phosphate, calcium dihydrogen phosphate, sodium pyrophosphate, sodium trimetaphosphate, sodium tripolyphosphate, trisodium phosphate, tripotassium phosphate, sodium dihydrogen phosphate, potassium dihydrogen phosphate, disodium hydrogen phosphate, dipotassium hydrogen phosphate, disodium dihydrogen pyrophosphate, magnesium hydrogen phosphate, trimagnesium phosphate, calcium sulfate, calcium hydroxide, potassium hydroxide, magnesium oxide, lactic acid, calcium lactate, sodium lactate, sodium carbonate, potassium carbonate, potassium bicarbonate, sodium bicarbonate, sodium sesquicarbonate, sodium acetate, sodium citrate, sodium dihydrogen citrate, and potassium citrate.

5. The stabilizing agent for reducing the leaching toxicity of heavy metals contained in foods, foodstuffs, Chinese herbs and enhancing food safety and environmental protection according to claim 1, wherein the chloride is one or more selected from sodium chloride, potassium chloride, calcium chloride, and magnesium chloride.

6. The stabilizing agent for reducing the leaching toxicity of heavy metals contained in foods, foodstuffs, Chinese herbs and enhancing food safety and environmental protection according to claim 1, wherein the amounts of the raw materials in percent by mass are as follows:

| | |
|---|---|
| The phosphoric acid or phosphate | 0.5-90%; |
| The acidity regulator | 0.5-65%; |
| The chloride | 0.5-40%. |

7. The stabilizing agent for reducing the leaching toxicity of heavy metals contained in foods, foodstuffs, Chinese herbs and enhancing food safety and environmental protection according to claim 1, wherein the raw materials of the stabilizing agent further comprise one or more selected from food or processed foodstuff containing dietary fiber, colloid, phlegm, or riched in or being able to increase probiotic bacteria, food-grade iron compound, antioxidant, thickener, nutrition enhancer, and preservative.

8. The stabilizing agent for reducing the leaching toxicity of heavy metals contained in foods, foodstuffs, Chinese herbs and enhancing food safety and environmental protection according to claim 7, wherein the food containing dietary fiber, colloid, phlegm, or riched in or being able to increase probiotic bacteria is one or more selected from fruits and vegetables, cereal grains, legumes, bacteria and algae foods; wherein the processed foodstuff containing dietary fiber, colloid, phlegm, or riched in or being able to increase probiotic bacteria is one or more selected from health care product, seasoning agent or thickener made from plants, vegetables, fruits, cereal grains, legumes, bacteria, algae or milk, as well as shell of shrimps, crabs, or insects.

9. The stabilizing agent for reducing the leaching toxicity of heavy metals contained in foods, foodstuffs, Chinese herbs and enhancing food safety and environmental protection according to claim 7, wherein the food-grade iron compound is one or more selected from iron oxide black, iron oxide red, ferrous sulfate, ferrous gluconate, ferric ammonium citrate, ferrous fumarate, ferric citrate, ferrous citrate, ferrous lactate, chlorohemin, ferric pyrophosphate, iron porphyrin, ferrous glycinate, reduced iron, ferric sodium EDTA, carbonyl iron powder, ferrous carbonate, ferrous fumarate, ferrous succinate, heme iron, and electrolytic iron.

10. The stabilizing agent for reducing the leaching toxicity of heavy metals contained in foods, foodstuffs, Chinese herbs and enhancing food safety and environmental protection according to claim 7, wherein the antioxidant is one or more selected from vitamin E, disodium EDTA, calcium disodium EDTA, sulfur dioxide, potassium metabisulfite, sodium metabisulfite, sodium sulfite, sodium hydrogen sulfite, sodium hydrosulfite, ascorbic acid, D-erythorbic acid and its sodium salt, sodium ascorbate, calcium ascorbate, ascorbyl palmitate, phospholipids, propyl gallate, antioxidant of glycyrrhiza, phytic acid, sodium phytate, bamboo leaf antioxidants, rosemary extract, tea polyphenols, tea polyphenols palmitate, lipoic acid, L-methionine, glutathione, cysteine and taurine.

11. The stabilizing agent for reducing the leaching toxicity of heavy metals contained in foods, foodstuffs, Chinese herbs and enhancing food safety and environmental protection according to claim 7, wherein the thickener is one or more selected from propylene glycol, tara gum, starch acetate, sodium carboxymethyl starch, acid-treated starch, sodium starch phosphate, aluminum starch octenylsuccinate, oxidized starch, oxidized hydroxypropyl starch, β-cyclodextrin, gum arabic, guar gum, carrageenan, Cassia tora, gelatin, curdlan, pectin, locust bean gum, funoran, ablmoschus manihot gums, xanthan gum, Sa-son seed gum, sesbania gum, linseed gum, gleditsia sinensis lain gum, gellan gum, agar, propylene glycol alginate, chitin, chitosan, alginic acid, sodium alginate, potassium alginate, maltitol, lactitol, sorbitol, pullulan, soluble soybean polysaccharide, tamarind polysaccharide gum, carboxymethyl cellulose, propyl methyl cellulose, carboxymnethyl cellulose sodium, polyglyceryl fatty acid ester, distarch phosphate, phosphated distarch phosphate, acetylated distarch phosphate, and acetylated distarch adipate.

12. The stabilizing agent for reducing the leaching toxicity of heavy metals contained in foods, foodstuffs, Chinese herbs and enhancing food safety and environmental protection according to claim 7, wherein the nutrition enhancer is one or more selected from calcium carbonate, calcium gluconate, calcium citrate, calcium lactate, calcium L-lactate, calcium hydrogen phosphate, calcium L-threonate, calcium glycinate, calcium aspartate, citric acid, calcium malate, calcium acetate, calcium chloride, tricalcium phosphate, vitamin E, calcium succinate, calcium glycerophosphate, calcium oxide, calcium sulfate, bone meal, sodium selenite, sodium selenate, selenium protein, selenium-rich edible fungus powder, L-selenium-methylselenocysteine, selenium carrageenan, selenium-rich yeast, casein phosphopeptide, casein calcium peptides, taurine, L-methionine, L-lysine, L-carnitine, vitamin B1, B2, B6, B12, and folic acid.

13. The stabilizing agent for reducing the leaching toxicity of heavy metals contained in foods, foodstuffs, Chinese herbs and enhancing food safety and environmental protection according to claim 7, wherein the preservative is one or more selected from potassium cinnamate, cinnamaldehyde, ε-polylysine hydrochloride, ε-polylysine, nisin, sodium diacetate, sorbic acid and its potassium salt.

14. The stabilizing agent for reducing the leaching toxicity of heavy metals contained in foods, foodstuffs, Chinese herbs and enhancing food safety and environmental protection according to claim 1, wherein the heavy metal is one or more selected from lead, cadmium, copper, arsenic and mercury.

15. A method for preparing a stabilizing agent for reducing the leaching toxicity of heavy metals contained in foods, foodstuffs, Chinese herbs and enhancing food safety and environmental protection, comprising:
weighting a phosphoric acid or phosphate, an acidity regulator and a chloride accurately in a certain ratio, respectively, feeding all of them into a mixer followed by evenly mixing with stirring in the mixer at normal temperature and pressure before packaging.
